(19) United States
(12) Patent Application Publication
(10) Pub. No.: US 2023/0342137 A1
(43) Pub. Date: Oct. 26, 2023

(54) INFORMATION PROCESSING APPARATUS

(71) Applicant: Sony Interactive Entertainment Inc., Tokyo (JP)

(72) Inventor: Akiyuki Hatakeyama, San Mateo, CA (US)

(73) Assignee: Sony Interactive Entertainment Inc., Tokyo (JP)

(21) Appl. No.: 18/249,611

(22) PCT Filed: Nov. 1, 2021
(86) PCT No.: PCT/JP2021/040241

§ 371 Date: Apr. 19, 2023

(30) Foreign Application Priority Data
Nov. 6, 2020 (JP) 2020-186010

(51) Int. Cl. G06F 8/65

(52) U.S. Cl. CPC G06F 8/65

(57) ABSTRACT

An information processing apparatus provides a patch file for executing second software which is a new version, to a recording device in which first software is recorded. In the information processing apparatus, a block information generation section generates reusable block arrangement information that defines correspondence between the block numbers of a plurality of data blocks included in the second software and the block numbers, in the first software, of common data blocks which are included in the first software and the second software in common. A differential data generation section generates differential data including a data block that is included in the second software but is not included in the first software. A patch file generation section generates a patch file including the differential data and the reusable block arrangement information.

### TECHNICAL FIELD

The present disclosure relates to a technology for updating or upgrading software.

### BACKGROUND ART

PTL 1 discloses differential information generating software that determines whether patch files of different versions have common data blocks that are identical to each other, by comparing respective hash values of the data blocks in these patch files.

### CITATION LIST

### Patent Literature

[PTL 1] JP-2015-207145 A

### SUMMARY

### Technical Problem

Game software includes a startup file, a file group for executing a game such as a game program, a file group for generating images and sounds, a file group that an operating system (OS) of a game apparatus uses, and the like. Increase in the data size of game software results in increase in a time to update or upgrade the game software.

Game software for console game machines has been developed by means of a development machine equipped with target hardware or a specific machine that is called a test machine (development use game machine), and a personal computer (PC). In order to execute updated software that is created by the PC, by means of the development use game machine for the purpose of conducting an operation check, it is necessary to make a copy of the game data in the PC onto the development use game machine. The operation check is conducted at close intervals. Therefore, it is inefficient to take a time for a data transfer each time the operation check is conducted.

After an operation check of updated software is finished in the development environment, the updated software is transferred to a diagnosis apparatus on a server system side, and is subjected to an additional operation check. Since a long time is taken to transfer the game data fully to the diagnosis apparatus, it is preferable to reduce the amount of data to be transferred.

After the diagnosis apparatus on the server system side conducts the operation check and the operation check is ended, the authored game software is uploaded to a distribution apparatus, so that a game machine of an end user can download the game software from the distribution apparatus. Since a long time is taken to download the game data fully, it is preferable to reduce the amount of data to be downloaded.

Therefore, an object of the present disclosure is to provide a technology for efficiently updating or upgrading software.

### Solution to Problem

In order to solve the above problems, a certain aspect of the present disclosure is an information processing apparatus that provides, to a recording device in which first software including a plurality of data blocks is recorded, a patch file for executing second software which is a newer version of the first software, the information processing apparatus including a block information generation section that generates reusable block arrangement information that defines correspondence between block numbers of a plurality of data blocks included in the second software and block numbers, in the first software, of common data blocks which are included in the first software and the second software in common, a differential data generation section that generates differential data including a data block that is included in the second software but is not included in the first software, a patch file generation section that generates a patch file including the differential data and the reusable block arrangement information, and a provision section that provides the patch file to the recording device.

Another aspect of the present disclosure is an information processing apparatus that processes second software, which is a newer version of first software recorded in a recording device, by using a plurality of data blocks included in the first software, the information processing apparatus including a record control section that acquires a patch file including differential data and reusable block arrangement information, and records the patch file into the recording device, and a processing section that processes the second software by using the first software and the patch file. The differential data includes a data block that is included in the second software but is not included in the first software. The reusable block arrangement information defines correspondence between block numbers of a plurality of data blocks included in the second software and block numbers, in the first software, of common data blocks which are included in the first software and the second software in common, and the processing section processes the second software by using the reusable block arrangement information, the first software, and the differential data.

A still another aspect of the present disclosure is an information processing apparatus that is capable of making access to a recording device in which first software including a plurality of data blocks is recorded and that is connected to a distribution apparatus for distributing software, the information processing apparatus including a block information acquisition section that acquires, from the distribution apparatus, reusable block arrangement information that defines correspondence between block numbers of a plurality of data blocks included in second software, and block numbers, in the first software, of common data blocks which are included in the first software and the second software in common, a differential data identification section that identifies, in the reusable block arrangement information, a block number in the second software having no correspondence with any of the block numbers in the first software, and a download execution section that downloads, from the distribution apparatus, a data block whose block number has been identified.

A yet another aspect of the present disclosure is an information processing apparatus that is connected to a distribution apparatus for distributing software, the information processing apparatus including a download request transmission section that transmits a download request for first software to the distribution apparatus, the download request including information regarding content that is not downloaded among contents included in the first software, a block information acquisition section that acquires, from the distribution apparatus, first download block information that associates a necessary data block among a plurality of data blocks included in the first software, with a corresponding block number, and associates an unnecessary data block among the plurality of data blocks, with information indicating that the data block is not downloaded, a download section that downloads, from the distribution apparatus, the data block associated with the block number included in the first download block information, and a recording device into which the first download block information and the downloaded data block are recorded.

A yet another aspect of the present disclosure is information processing apparatus that copies software recorded in a second recording device, to a first recording device, the information processing apparatus including a record control section. Software from which a part of content in full-version software has been eliminated and selection block arrangement information that associates block numbers of a plurality of data blocks in the full-version software with block numbers of data blocks in the software recorded in the second recording device, are recorded in the second recording device, and when copying the software recorded in the second recording device to the first recording device, the record control section generates present block arrangement information that associates a present data block among a plurality of data blocks in the full-version software with a corresponding block number, and associates a non-present data block with information indicating that the data block is not present, on the basis of the selection block arrangement information, and records the present block arrangement information into the first recording device.

It is to be noted that any combinations of the constituent components described above and the expressions of the present disclosure that are converted between an apparatus, a system, a recording medium, or a computer program are also effective as aspects of the present disclosure.

### BRIEF DESCRIPTION OF DRAWINGS

FIG. 1 is a diagram depicting an information processing system according to an embodiment of the present disclosure.

FIG. 2 is a diagram depicting functional blocks of a PC and a development use game machine.

FIG. 3(a) depicts an example of first software, FIG. 3(b) depicts an example of second software, and FIG. 3(c) depicts an example of a patch file.

FIG. 4(a) depicts an example of first software, FIG. 4(b) depicts an example of a patch file, and FIG. 4(c) depicts an example of second software.

FIG. 5 is a diagram depicting functional blocks of a distribution apparatus and a game machine.

FIG. 6(a) depicts an example of first software, FIG. 6(b) depicts an example of second software, and FIG. 6(c) depicts an example of reusable block arrangement information 126.

FIG. 7 is a sequence diagram that indicates a download procedure.

FIG. 8 is a diagram depicting functional blocks of a distribution apparatus and a game machine.

FIG. 9(a) depicts an example of first software, FIG. 9(b) depicts first download block information, and FIG. 9(c) depicts an example of first software 168.

FIG. 10 is a sequence diagram that indicates a download procedure.

FIG. 11 is a diagram depicting a state of a recording device of a game machine.

FIG. 12 is a diagram depicting a state in which second software is downloadable.

FIG. 13(a) depicts an example of second software, FIG. 13(b) depicts an example of reusable block arrangement information, FIG. 13(c) depicts an example of second download block information, and FIG. 13(d) depicts an example of first download block information 166.

FIG. 14 is a sequence diagram that indicates a download procedure.

FIG. 15 is a diagram depicting a game machine provided with two recording devices.

### DESCRIPTION OF EMBODIMENTS

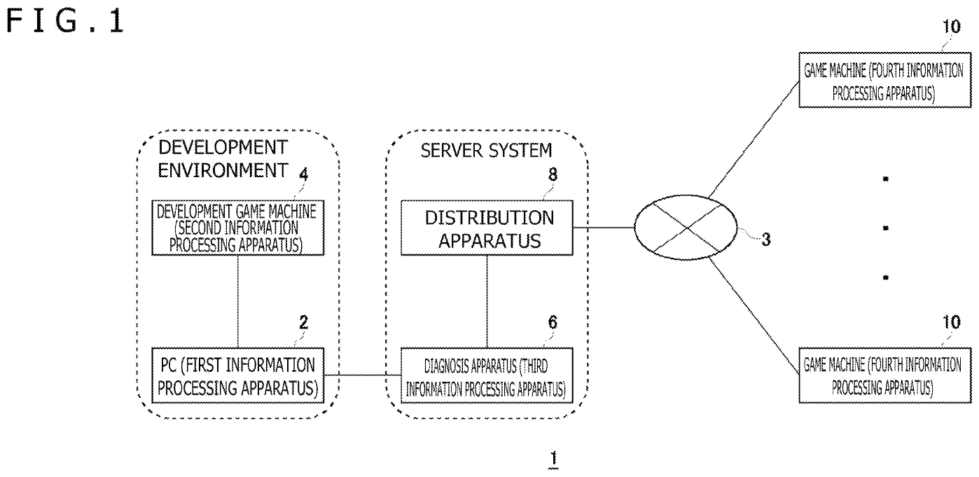

FIG. 1 depicts an information processing system 1 according to an embodiment of the present disclosure. The information processing system 1 forms a mechanism for efficiently updating/upgrading (hereinafter, simply referred to as “updating”) software. In the embodiment, the software may be game software, or may be any other kind of software.

The information processing system 1 includes a personal computer (hereinafter, referred to as “PC”) 2 and a development use game machine 4 which are in a development environment, a diagnosis apparatus 6 and a distribution apparatus 8 which are in a server system, and a plurality of game machines 10. The plurality of game machines 10 are connected to the distribution apparatus 8 over a network 3 which is the internet, for example. In the information processing system 1, the PC 2, the development use game machine 4, the diagnosis apparatus 6, and the game machine 10 each serve as an information processing apparatus. The PC 2, the development use game machine 4, the diagnosis apparatus 6, and the game machines 10 may be referred to as a first information processing apparatus, a second information processing apparatus, a third information processing apparatus, and fourth information processing apparatuses, respectively.

In the development environment, the development use game machine 4 is equipped with target hardware for the game machines 10 which are console game machines. By using the PC 2, a game developer updates game software, installs the game data as a product onto the development use game machine 4. If game data that has been already installed in the development use game machine 4 can be reused, the size of game data to be now installed to the development use game machine 4 can be made small. The PC 2 which is a first information processing apparatus has a function of providing updated game data to the development use game machine 4 such that game data already installed in the development use game machine 4 which is a second information processing apparatus is reused.

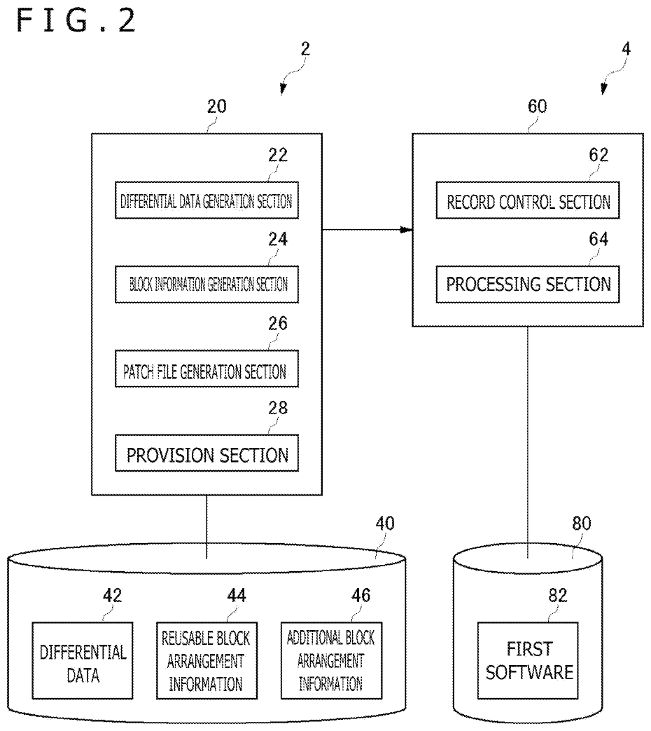

FIG. 2 depicts functional blocks of the PC 2 and the development use game machine 4 in a development environment. The PC 2 includes a processing device 20 and a recording device 40. The processing device 20 includes a differential data generation section 22, a block information generation section 24, a patch file generation section 26, and a provision section 28. The development use game machine 4 includes a processing device 60 and a recording device 80. The processing device 60 includes a record control section 62 and a processing section 64. First software 82 is recorded in the recording device 80 of the development use game machine 4.

The above sections are implemented by a central processing unit (CPU) and a memory of an optional computer, a program loaded in the memory, a storage, and the like, in terms of hardware components. However, the functional blocks that are implemented by cooperation among a CPU, a memory, a program, a storage, and the like are illustrated in the drawing. A person skilled in the art can understand that the above functional blocks can be implemented in many ways by hardware alone, software alone, or a combination thereof.

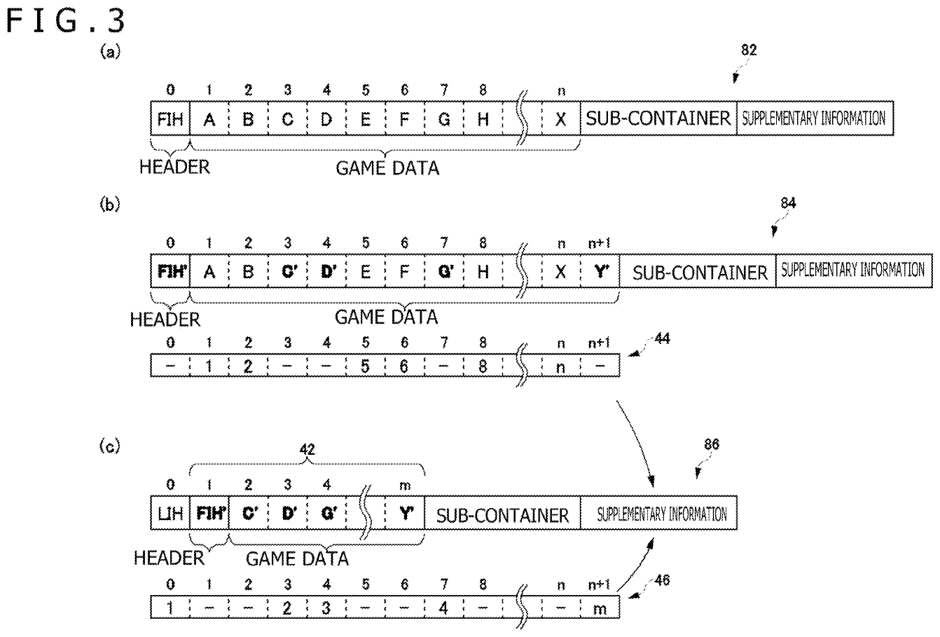

FIG. 3(a) depicts an example of the first software 82 that is recorded in the recording device 80. The format of the first software 82 includes a header (FIH) area, a game data area, a sub-container area, and a supplementary information area.

The game data area includes a game program and various kinds of data sets (hereinafter, collectively referred to as “game data”), and is formed of a plurality of data blocks. Each of the data blocks has a prescribed block size which is set to 64 kilobytes, for example. In FIG. 3(a), the game data of the first software 82 is formed of n data blocks.

The header (FIH) area includes header information of the game data, and is formed of a single data block. The header (FIH) information includes offset information on a super block of the game data, and offset information of a sub-container.

The sub-container area includes license-related information, and offset information on the supplementary information. The sub-container area according to the embodiment does not have alignment of data blocks, but may be formed of a plurality of data blocks. The supplementary information area includes information that is not distributed to an end user, and thus, the supplementary information is not contained in distribution data when the software is distributed from the distribution apparatus 8 to an end user. The supplementary information area is contained in a package formed only when game data created by the PC 2 is installed to the development use game machine 4 and when game data created by the PC 2 is uploaded to the diagnosis apparatus 6. In the embodiment, the supplementary information area includes data block arrangement information that is for reuse of the game data.

A description will be given below of a method for a game developer installing game data as a product, to the development use game machine 4 by using the PC 2 in a state in which the first software 82 is recorded in the recording device 80 of the development use game machine 4.

FIG. 3(b) depicts an example of updated second software 84. The version of the second software 84 is newer than the version of the first software 82. It is to be noted that the second software 84 arranged in the format depicted in FIG. 3(b) is given for easy understanding. The PC 2 does not create the second software 84 depicted in FIG. 3(b). In a development environment, the PC 2 generates a patch file 86 depicted in FIG. 3(c), and provides the patch file 86 to the development use game machine 4, which will described later. Then, the development use game machine 4 processes the second software 84 on the basis of the first software 82 and the patch file 86.

In the second software 84, some of the data blocks in the first software 82 have been updated. Compared to the first software 82 in FIG. 3(a), a header (FIH′) whose block number is “0,” a data block C′ whose block number is 3, a data block D′ whose block number is 4, and a data block G′ whose block number is 7 are updated, and a data block Y′ whose block number is (n+1) are added in the second software 84.

The block information generation section 24 generates reusable block arrangement information 44 that defines correspondence between the block numbers of a plurality of data blocks included in the second software 84 and the block numbers, in the first software 82, of common data blocks which are included in the first software 82 and the second software 84 in common. It is to be noted that the common data blocks refer to data blocks in which the same data is recoded. In other words, the common data blocks refer to reusable data blocks.

The reusable block arrangement information 44 defines correspondence between the block numbers of the data blocks in the second software 84, which are depicted on the upper side, and the block numbers, in the first software 82, of the common data blocks, which are depicted on the lower side. That is, the lower side designates the block numbers of the data blocks in the first software 82 having the same data as that in the second software 84 recorded therein.

In the present example, the data block whose block number is 1 in the second software 84 is identical to the data block whose block number is 1 in the first software 82, while the data block whose block number is 2 in the second software 84 is identical to the data block whose block number is 2 in the first software 82.

In the reusable block arrangement information 44, “-” which is depicted on the lower side, indicates that the first software 82 does not include data block that has recorded the same data as the corresponding data block in the second software 84. In the present example, the data blocks whose block numbers are 0, 3, 4, 7, . . . , (n+1) in the second software 84 are not included in the first software 82. In this manner, the reusable block arrangement information 44 includes information for identifying which data block in the first software 82 is reusable, and further identifying which data block in the second software 84 is not included in the first software 82.

The differential data generation section 22 generates differential data 42 including a data block that is included in the second software 84 and is not included in the first software 82. In the second software 84, the header (FIH′) whose block number is “0,” the data block C′ whose block number is 3, the data block D′ whose block number is 4, and the data block G′ whose block number is 7 are updated data blocks, and the data block Y′ whose block number is (n+1) is an added data block, as previously explained. Therefore, the differential data generation section 22 generates the differential data 42 in which the data blocks are arranged in ascending order of the block numbers in the second software 84.

FIG. 3(c) depicts an example of a patch file 86. The patch file generation section 26 generates the patch file 86 that includes at least the differential data 42. The patch file generation section 26 puts a header (LIH) of the differential data 42 in a data block whose block number is 0, and puts the differential data 42 in data blocks whose block numbers are 1 and greater.

The block information generation section 24 generates additional block arrangement information 46 that defines correspondence between the block numbers of the plurality of data blocks included in the second software 84 and the block numbers of data blocks in the patch file 86.

The additional block arrangement information 46 defines correspondence between the block numbers of data blocks in the second software 84, which are depicted on the upper side, and the block numbers of the data blocks in the patch file 86, which are depicted on the lower side. In the present example, the data block whose block number is 0 in the second software 84 is identical to the data block whose block number is 1 in the patch file 86, while the data block whose block number is 3 in the second software 84 is identical to the data block whose block number is 2 in the patch file 86.

In the additional block arrangement information 46, “-” which is depicted on the lower side, indicates that the patch file 86 includes no data block that has recorded therein the same data as any one of the data blocks in the second software 84. In the present example, the data blocks whose block numbers are 1, 2, 5, 6, 8, . . . , n in the second software 84 are not included in the patch file 86. In this manner, the additional block arrangement information 46 includes information for identifying, in the patch file 86, which data block is to be used from the second software 84.

Correspondence between the block numbers of data blocks included in the second software 84 and either the block numbers of data blocks in the first software 82 or the block numbers of data blocks in the patch file 86 is defined by the reusable block arrangement information 44 and the additional block arrangement information 46. Accordingly, the header and all the data blocks constituting the game data in the second software 84 are each included in either the first software 82 or the patch file 86.

The patch file generation section 26 generates the patch file 86 that includes the differential data 42, the reusable block arrangement information 44, and the additional block arrangement information 46. Since the reusable block arrangement information 44 and the additional block arrangement information 46 are used by the development use game machine 4, the reusable block arrangement information 44 and the additional block arrangement information 46 may be put in the supplementary information area. For example, to check operation of the second software 84, the patch file generation section 26 generates the patch file 86, and the provision section 28 provides the patch file 86 to the development use game machine 4.

The development use game machine 4 has a function of processing second the software 84 which is a new version of the first software 82 by using a plurality of data blocks included in the first software 82 recorded in the recording device 80.

After the patch file 86 is provided from the PC 2, the record control section 62 acquires the patch file 86, and records the patch file 86 into the recording device 80. Accordingly, the first software 82 and the patch file 86 are recorded in the recording device 80.

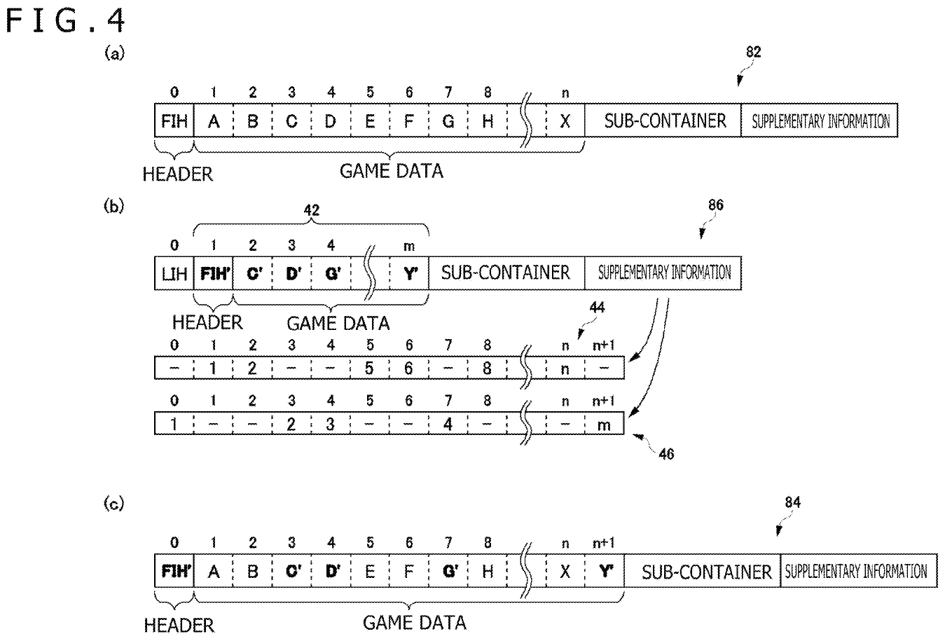

FIG. 4(a) depicts an example of the first software 82. FIG. 4(b) depicts an example of the patch file 86. The supplementary information area in the patch file 86 includes the reusable block arrangement information 44 and the additional block arrangement information 46.

The processing section 64 has a function of processing the second software 84 by using the first software 82 and the patch file 86. Specifically, the processing section 64 processes the second software 84 by using the reusable block arrangement information 44, the additional block arrangement information 46, the first software 82, and the differential data 42. Here, the term “processing” refers to executing the second software 84 to conduct an operation check. For example, this term may refer to reforming the second software 84 into the format depicted in FIG. 4(c).

As described so far, to check operation of the updated second software 84 in a development environment, the PC 2 generates the patch file 86 that includes only updated data blocks as the differential data 42, and provides the patch file 86 to the development use game machine 4. This offers an advantageous effect that an amount of data transferred between the PC 2 and the development use game machine 4 can be reduced.

It is to be noted that, as depicted in FIG. 4(b), the reusable block arrangement information 44 and the additional block arrangement information 46 are complementary to each other, and further, updated data blocks in the second software 84 are arranged, in the differential data 42, in ascending order of the block numbers. For this reason, if the reusable block arrangement information 44 is provided, the additional block arrangement information 46 can be generated from the reusable block arrangement information 44.

Therefore, in the PC 2, the block information generation section 24 does not need to generate the additional block arrangement information 46. Accordingly, the patch file generation section 26 does not need to add the additional block arrangement information 46 to the patch file. In this case, it is sufficient that, when processing the second software 84, the processing section 64 of the development use game machine 4 may temporarily generate and acquire the additional block arrangement information 46 from the reusable block arrangement information 44.

The method for reducing the amount of a data transfer between the PC 2 and the development use game machine 4 by providing the patch file 86 to the recording device 80 of the development use game machine 4 in a development environment so as to allow the development use game machine 4 to process the second software 84, has been described so far. This method is also applicable to a data transfer between the PC 2 which is the first information processing apparatus and the diagnosis apparatus 6 which is the third information processing apparatus. Further, if the PC 2 provides the patch file 86 in a state in which the first software 82 is installed in the diagnosis apparatus 6, the diagnosis apparatus 6 can execute the second software 84.

After checking operation of the second software 84, the diagnosis apparatus 6 forms the second software 84 of the latest version in a format such as that depicted in FIG. 4(c), by combining the first software 82 and the patch file 86. It is to be noted that the second software 84 to be distributed includes no supplementary information, as previously described. The diagnosis apparatus 6 forms the second software 84, and uploads the second software 84 to the distribution apparatus 8. As a result, a user can download the latest second software 84 from the distribution apparatus 8 onto the game machine 10, and can execute the second software 84.

If game data that has been already installed in the game machine 10 is reusable, the size of game data to be downloaded from the distribution apparatus 8 can be made smaller. For this reason, the game machine 10 which is a fourth information processing apparatus acquires, from the distribution apparatus 8, reusable block arrangement information that is for reuse of the installed game data, and then, efficiently downloads updated game data.

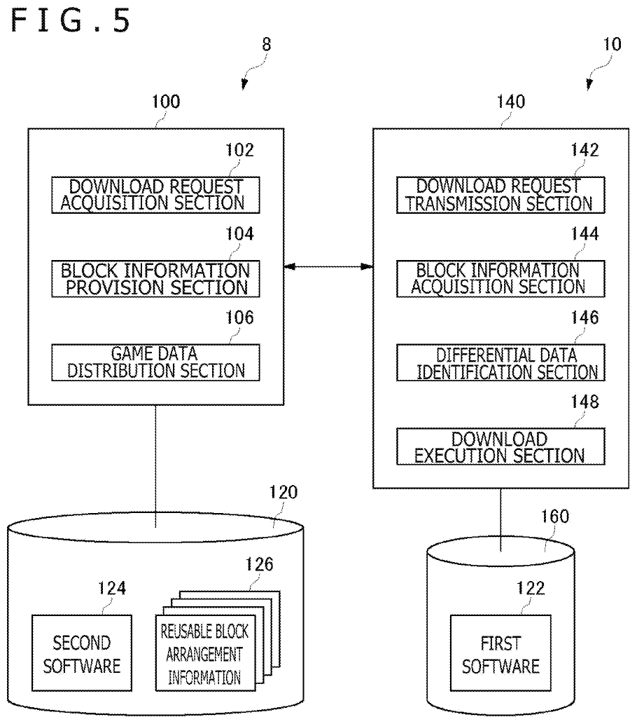

FIG. 5 depicts functional blocks of the distribution apparatus 8 and the game machine 10. The distribution apparatus 8 includes a processing device 100 and a recording device 120. The processing device 100 includes a download request acquisition section 102, a block information provision section 104, and a game data distribution section 106. The game machine 10 includes a processing device 140 and a recording device 160. The processing device 140 includes a download request transmission section 142, a block information acquisition section 144, a differential data identification section 146, and a download execution section 148. The processing device 140 of the game machine 10 can make access to the recording device 160. First software 122 is recorded in the recording device 160.

The above sections are implemented by a CPU and a memory of any computer, a program loaded in the memory, a storage, and the like, in terms of hardware components. However, the functional blocks that are implemented by cooperation among a CPU, a memory, a program, a storage, and the like are illustrated in the drawing. A person skilled in the art can understand that the above functional blocks can be implemented in many ways by hardware alone, software alone, or a combination thereof.

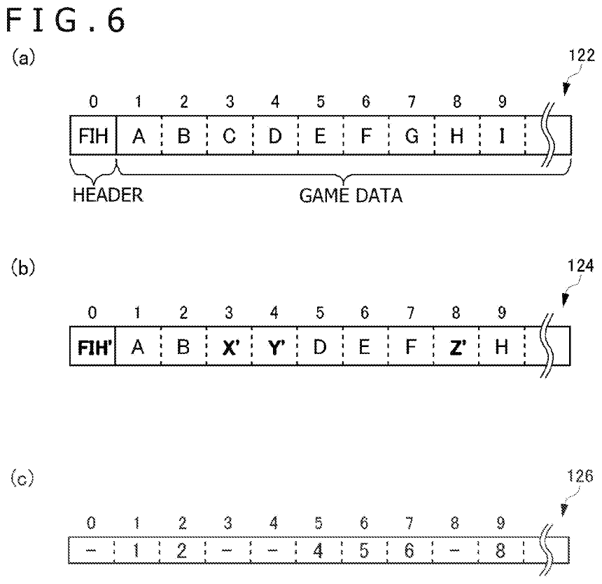

FIG. 6(a) depicts an example of the first software 122 recorded in the recording device 160. The format of the first software 122 includes a header (FIH) area, a game data area, and a sub-container area. A description of the sub-container area will be omitted.

The game data area includes game data, and is formed of a plurality of data blocks. Each of the data blocks may have a prescribed block size, and may be signed and encrypted. The header (FIH) area includes header information of the game data, and is formed of a single data block. The header (FIH) information includes offset information on a super block of the game data, and offset information of a sub-container.

A description will be given of a method in which a user operates the game machine 10 to install second software 124 of the latest version into the game machine 10 in a state in which the first software 122 has been recorded in the recording device 160.

FIG. 6(b) depicts an example of the second software 124. In the distribution apparatus 8, the second software 124 of the latest version and a plurality of sets of the reusable block arrangement information 126 are recorded in the recording device 120. The sets of the reusable block arrangement information 126 are prepared for respective older versions of the first software 122 older than the second software 124. Therefore, when the number of the versions older than the latest version is N, N sets of the reusable block arrangement information 126 are prepared. To upload the second software 124 of the latest version to the distribution apparatus 8, the diagnosis apparatus 6 may identify identical data blocks by comparing a hash value of each data block of the second software 124 with a hash value of each data block of the first software 122 of an older version, generate the reusable block arrangement information 126 for each version, and provide the reusable block arrangement information 126 to the distribution apparatus 8.

The reusable block arrangement information 126 defines correspondence between the block numbers of a plurality of data blocks included in the second software 124 of the latest version and the block numbers, in the first software, of common data blocks which are included in the first software 122 and the second software 124 in common. It is to be noted that the common data blocks have identical data recorded therein. In other words, the common data blocks are reusable.

FIG. 6(c) depicts an example of the reusable block arrangement information 126. The reusable block arrangement information 126 defines correspondence between the block numbers of the data blocks in the second software 124, which are depicted on the upper side, and the block numbers, in the first software 122, of the common data blocks which are depicted on the lower side. That is, the lower side designates the block numbers of the data blocks in the first software 122 having the same data as that in the second software 124 recorded therein.

In the present example, the data block whose block number is 1 in the second software 124 is identical to the data block whose block number is 1 in the first software 122, and the data block whose block number is 2 in the second software 124 is identical to the data block whose block number is 2 in the first software 122. Also, the data blocks whose block numbers are 5, 6, and 7 in the second software 124 are identical to the data blocks whose block numbers are 4, 5, and 6, in the first software 122, respectively. The data block whose block number is 9 in the second software 124 is identical to the data block whose block number is 8 in the first software 122.

In the reusable block arrangement information 126, “-” which is depicted on the lower side, indicates that the first software 122 does not include data block that has recorded the same data as any one of the data blocks in the second software 124. In the present example, the data blocks whose block numbers are 0, 3, 4, 8, . . . in the second software 124 are not included in the first software 122. In this manner, the reusable block arrangement information 126 includes information for identifying which data block in the first software 122 is reusable, and further identifying which data block in the second software 124 is not included in the first software 122 but is included in the second software 124.

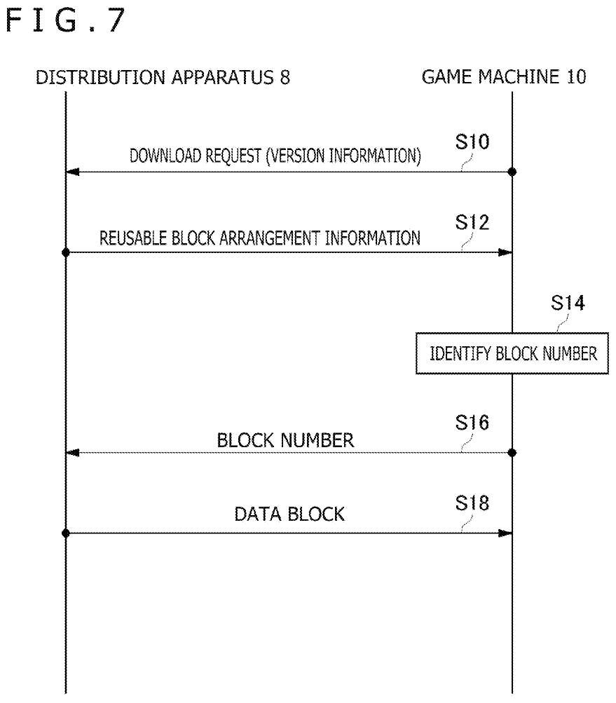

FIG. 7 is a sequence diagram that indicates a downloading procedure in the game machine 10. In the game machine 10, the download request transmission section 142 transmits a download request for the second software 124 of the latest version to the distribution apparatus 8 (S10). The download request includes the version information on the installed first software 122.

In the distribution apparatus 8, the download request acquisition section 102 acquires the download request from the game machine 10, and passes the download request to the block information provision section 104. The block information provision section 104 extracts version information included in the download request, reads out the reusable block arrangement information 126 that corresponds to the version information from the recording device 120, and transmits the version information to the game machine 10 (S12).

In the game machine 10, the block information acquisition section 144 acquires the reusable block arrangement information 126 from the distribution apparatus 8, and records the reusable block arrangement information 126 into the recording device 160. The differential data identification section 146 identifies, in the reusable block arrangement information 126, a block number in the second software 124 that does not correspond to any of the block numbers in the first software 122 (S14).

With reference to FIG. 6(c), the differential data identification section 146 confirms that the block numbers 0, 3, 4, and 8 in the second software 124 do not correspond to any of the block numbers in the first software 122. Since the data blocks corresponding to these block numbers are not included in the first software 122, it is necessary to download the data blocks from the distribution apparatus 8. The download execution section 148 reports the block numbers identified by the differential data identification section 146, in ascending order of the block numbers, to the distribution apparatus 8 (S16).

In the distribution apparatus 8, the game data distribution section 106 distributes the data blocks whose block numbers in the second software 124 have been reported, to the game machine 10 (S18). In the present example, the game data distribution section 106 receives, from the game machine 10, the block numbers “0,” “3,” “4,” and “8,” which are targets to be distributed, in this order, and thus, distributes, to the game machine 10, the corresponding data blocks in the second software 124 in this order.

In the game machine 10, the download execution section 148 downloads the data blocks having the block numbers in the second software 124 identified by the differential data identification section 146, and records the data blocks into the recording device 160. In this manner, the game machine 10 downloads only a data block in the second software 124 that is not included in the first software 122 already recorded in the recording device 160. Accordingly, the amount of data to be downloaded can be reduced.

In recent years, many games have been created so as to be performed among many countries having different languages. Sound data and image data have been created so as to support multiple languages. Sound files and image files in multiple languages are contained in the full version of package software. It is assumed that such files are referred to as “language-dependent” files. The data size of the language-dependent files is so large that the language-dependent files occupy a large proportion of the total data size of the full version of the game software. Thus, game software according to the embodiment includes a group of language resource files which are obtained by combining sound files and image files for respective languages, and a user can acquire a necessary language-dependent file alone.

Further, a game has a variety of play modes. Examples of such play modes include a single play mode in which a user plays the game alone, and a multi-play mode in which a plurality of users play the game together. Game software includes files for respective play modes. With the information processing system 1 according to the embodiment, a user is allowed to download a file of a desired play mode and not to download a file of a play mode that is not desired. Accordingly, a situation in which game data for a play mode that is not used into the recording device 160 of the game machine 10 is saved can be avoided.

For the aforementioned reasons, the game machine 10 according to the embodiment can download only a part of full game data included in the full version of the game software, and execute the game software. The full version of the game software here refers to software that includes language-dependent files for all languages and game data for all play modes. For example, if a user selects to download a Japanese language-dependent file only, the game machine 10 refrains from downloading language-dependent files for the remaining languages. In addition, if a user selects to download a game file of a single play mode without selecting to download a game file of a multi-play mode, the game machine 10 refrains from downloading a game file for the multi-play mode.

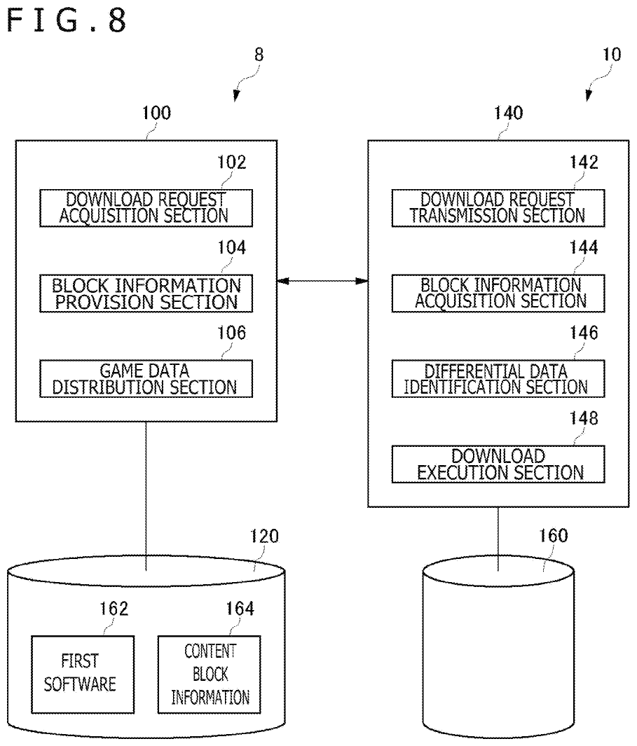

FIG. 8 depicts functional blocks of the distribution apparatus 8 and the game machine 10. The distribution apparatus 8 includes the processing device 100 and the recording device 120. The processing device 100 includes the download request acquisition section 102, the block information provision section 104, and the game data distribution section 106. The game machine 10 includes the processing device 140 and the recording device 160. The processing device 140 includes the download request transmission section 142, the block information acquisition section 144, the differential data identification section 146, and the download execution section 148.

Hereinafter, a description will be given of a case where, when downloading the first software 162 from the distribution apparatus 8, a user selects a language-dependent file or a play mode such that downloading of a part of the game data is omitted. A language-dependent file and a file for executing a play mode are collectively expressed as “content.”

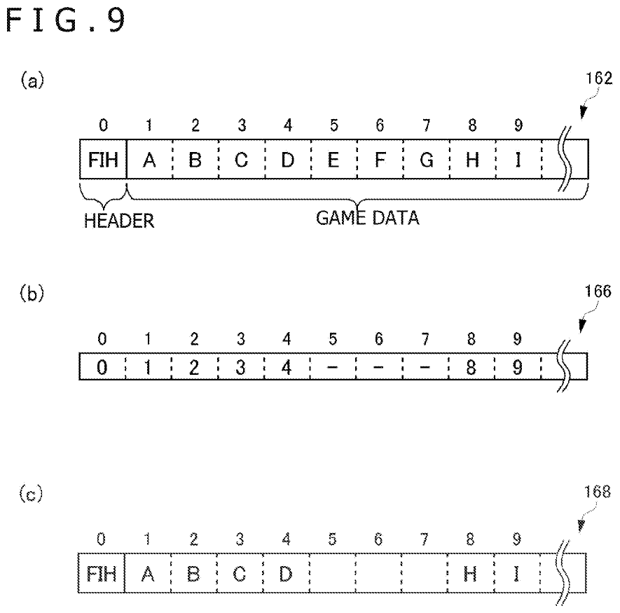

FIG. 9(a) depicts an example of first software 162 recorded in the recording device 120. The format of the first software 162 includes a header (FIH) area, a game data area, and a sub-container area. A description of the sub-container area will be omitted. The game data area includes game data, and is formed of a plurality of data blocks. Each of the data blocks may have a prescribed block size, and may be signed and encrypted. The first software 162 held in the distribution apparatus 8 is the full version of game software. The game data area in the first software 162 includes all language-dependent files and game files for all play modes.

In an example which will be given below, when downloading the first software 162, a user designates information regarding content that is not downloaded, among contents included in the first software 162. Content that is not downloaded includes a language-dependent file that is not downloaded, and game data for executing a play mode that is not downloaded.

The user may designate information regarding content that is not downloaded, by specifying information regarding content that is to be downloaded, among the contents included in the first software 162. For example, the user may designate a language-dependent file that is not downloaded, by selecting to download a Japanese language-dependent file without selecting to download the remaining language-dependent files. In addition, the user may designate game data for a multi-play mode that is not downloaded, by selecting to download game data for a single play mode without selecting to download game data for a multi-play mode.

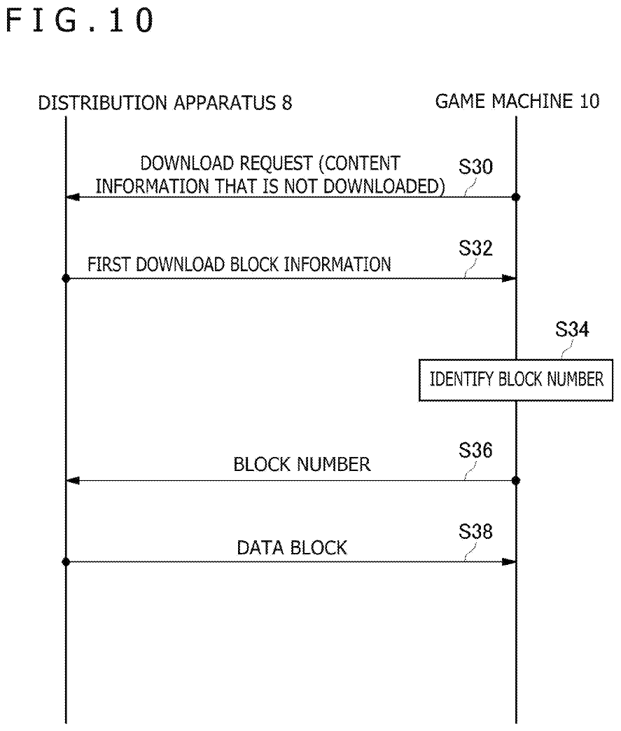

FIG. 10 is a sequence diagram that indicates a download procedure in the game machine 10. In the game machine 10, the download request transmission section 142 transmits a download request for the first software 162 to the distribution apparatus 8 (S30). The download request includes information regarding content that is not downloaded among contents included in the first software 162.

In the distribution apparatus 8, the download request acquisition section 102 acquires the download request from the game machine 10, and passes the download request to the block information provision section 104. Content block information 164 recorded in the recording device 120 includes information that indicates the block number of a data block that corresponds to the content. The block information provision section 104 extracts, from the download request, the information regarding the content that is not downloaded, and generates first download block information 166 with reference to the content block information 164 that corresponds to the extracted information.

Specifically, the block information provision section 104 identifies a data block of content downloading of which is unnecessary, with reference to the content block information 164, and generates the first download block information 166. The first download block information 166 is obtained by associating a necessary data block among a plurality of data blocks included in the first software 162 with the block number of the corresponding data block, and by associating an unnecessary data block among the plurality of data blocks, with information indicating that the data block is not downloaded.

FIG. 9(b) depicts an example of the first download block information 166. The first download block information 166 defines correspondence between the block numbers of data blocks in the first software 162, which are depicted on the upper side, and the block numbers in the first software 162, which are depicted on the lower side. That is, if a data block whose block number corresponds to any one of the block numbers on the lower side, the data block is to be downloaded. In the present example, the data blocks whose block numbers are 0, 1, 2, 3, 4, 8, 9, . . . are set as targets to be downloaded.

In the first download block information 166, “-” which is depicted on the lower side, indicates that the corresponding data block is not to be downloaded. As previously explained, a data block that is not to be downloaded means a data block including content that does not need to be downloaded. In the present example, it is set that the data blocks whose block numbers are 5, 6, 7, . . . are not targets to be downloaded.

The block information provision section 104 generates the first download block information 166 on the basis of the content block information 164 and the information regarding content that is not downloaded in the download request, and transmits the first download block information 166 to the game machine 10 (S32).

In the game machine 10, the block information acquisition section 144 acquires the first download block information 166 from the distribution apparatus 8, and records the first download block information 166 into the recording device 160. The download execution section 148 identifies a data block associated with a block number included in the first download block information 166 (S34). In the present example, the download execution section 148 identifies, as block numbers of data blocks that are downloaded, block numbers 0, 1, 2, 3, 4, 8, 9, . . . . The download execution section 148 reports the identified block numbers in ascending order to the distribution apparatus 8 (S36).

In the distribution apparatus 8, the game data distribution section 106 distributes the data blocks in the first software 162 whose block numbers have been reported, to the game machine 10. In the present example, the game data distribution section 106 receives, from the game machine 10, the block numbers “0,” “1,” “2,” “3,” “4,” “8,” “9,” which are targets to be distributed, in this order, and thus, distributes, to the game machine 10, the corresponding data blocks in the first software 162 in this order.

In the game machine 10, the download execution section 148 downloads necessary data blocks in the first software 162, and records the necessary data blocks into the recording device 160 (S38).

FIG. 9(c) indicates an example of the first software 168 recorded in the recording device 160. Compared to the first software 162 of the full version, the first software 168 does not include a part of the data blocks. Thus, the game machine 10 downloads only necessary game data. Accordingly, the amount of the downloaded data can be reduced.

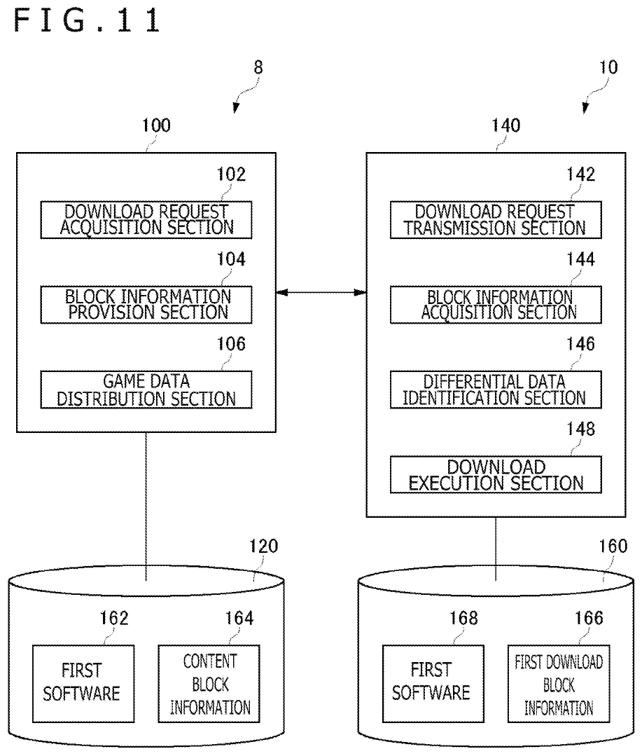

FIG. 11 depicts a state in which the first software 168 and the first download block information 166 have been recorded in the recording device 160 of the game machine 10. By causing the processing device 140 to execute the first software 168, a user can play a game in a selected language and/or in a selected play mode.

Next, a description will be given of a method by which, while the first software 168 is recorded in the recording device 160, a user operates the game machine 10 to install second software 170 of the latest version into the game machine 10.

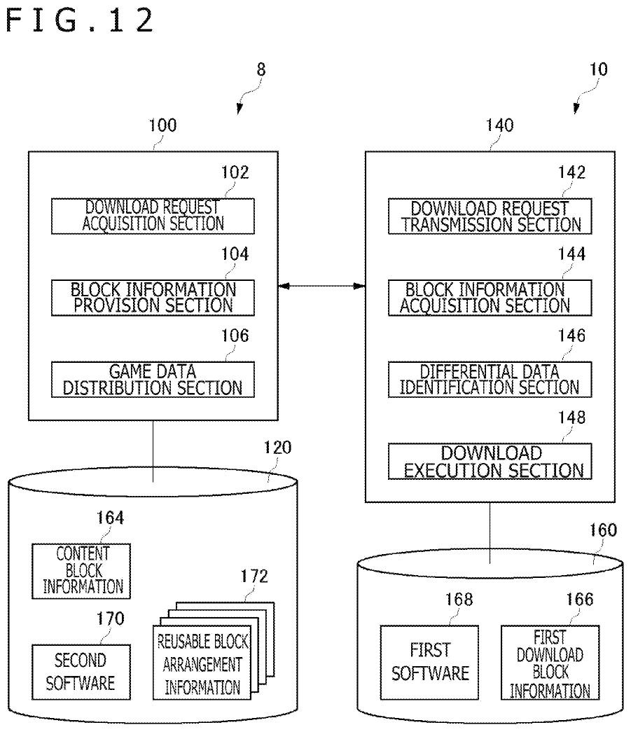

FIG. 12 depicts a state in which second software 170 of the latest version is downloadable. In the distribution apparatus 8, the content block information 164, the second software 170 of the latest full version, and multiple sets of reusable block arrangement information 172 are recorded in the recording device 120. The content block information 164 includes information indicating the block number of a data block that corresponds to content included in the second the software 170.

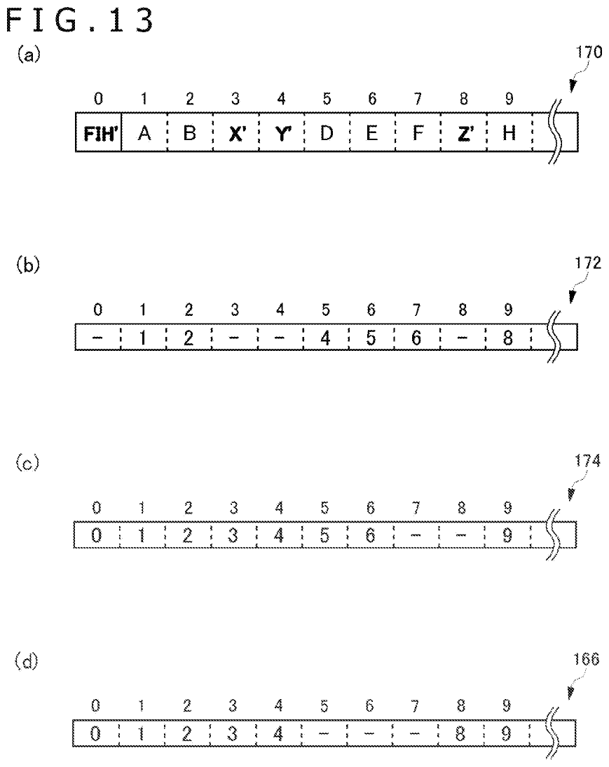

FIG. 13(a) depicts an example of the second software 170 of the full version. The data blocks whose block numbers are 0, 3, 4, and 8 in the second software 170, are not included in the first software 162.

The sets of the reusable block arrangement information 172 are prepared for respective versions of the first software 162 older than the second software 170. Therefore, when the number of the versions older than the latest version is N, N sets of the reusable block arrangement information 172 are prepared.

The reusable block arrangement information 172 defines correspondence between the block numbers of a plurality of data blocks included in the second software 170 of the latest version and the block numbers, in the first software, of common data blocks which are included in the first software 162 and the second software 170 in common. It is to be noted that the common data blocks refer to data blocks having the same data recoded therein. In other words, the common data blocks refer to reusable data blocks.

FIG. 13(b) depicts an example of the reusable block arrangement information 172. The reusable block arrangement information 172 defines correspondence between the block numbers of data blocks in the second software 170, which are depicted on the upper side, and the block numbers of common data blocks in the first software 162, which are depicted on the lower side. That is, the lower side designates the block numbers of the data blocks in the first software 162 having the same data as that in data blocks in the second software 170.

In the present example, the data block whose block number is 1 in the second software 170 is identical to the data block whose block number is 1 in the first software 162, and the data block whose block number is 2 in the second software 170 is identical to the data block whose block number is 2 in the first software 162. Further, the data blocks whose block numbers are 5, 6, and 7 in the second software 170 are identical to the data blocks whose block numbers are 4, 5, and 6 in the first software 162, respectively, and the data block whose block number is 9 in the second software 170 is identical to the data block whose block number is 8 in the first software 162.

In the reusable block arrangement information 126, “-” which is depicted on the lower side, indicates that the first software 162 includes no data block that has recorded the same data as any one of the data blocks in the second software 170. In the present example, the data blocks whose block numbers are 0, 3, 4, 8, . . . in the second software 170 are not included in the first software 162. In this manner, the reusable block arrangement information 172 includes information for identifying which data block in the first software 162 is reusable, and further identifying which data block in the second software 170 is not included in the first software 162.

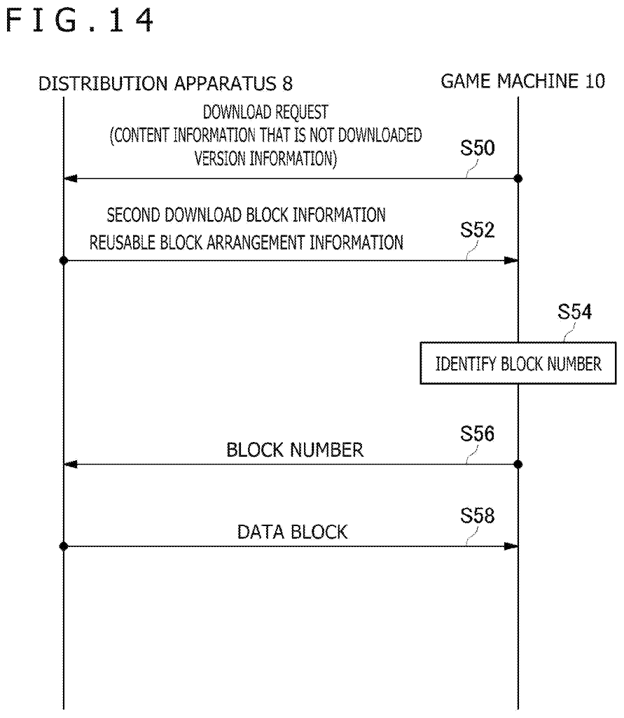

FIG. 14 is a sequence diagram that indicates a downloading procedure in the game machine 10. In the game machine 10, the download request transmission section 142 transmits a download request for the second software 170 of the latest version to the distribution apparatus 8 (S50). The download request includes information regarding content that is not downloaded among contents included in the second software 170, and the version information on the first software 162 (first software 168) that has already been installed.

In the distribution apparatus 8, the download request acquisition section 102 acquires the download request from the game machine 10, and passes the download request to the block information provision section 104. The content block information 164 recorded in the recording device 120 includes information indicating the block number of a data block corresponding to the content. The block information provision section 104 extracts, from the download request, information regarding content that is not downloaded, and generates second download block information 174 while referring to the content block information 164 that corresponds to the extracted information.

Specifically, the block information provision section 104 identifies a data block including content that is not needed to be downloaded, while referring to the content block information 164, and generates the second download block information 174. The second download block information 174 associates a necessary data block among a plurality of data blocks included in the second software 170, with the corresponding block number, and associates an unnecessary data block among the plurality of data blocks with information indicating that the data block is not downloaded.

FIG. 13(c) depicts an example of the second download block information 174. The second download block information 174 defines correspondence between the block numbers of data blocks in the second software 170, which are depicted on the upper side, and the block numbers in the second software 170, which are depicted on the lower side. That is, if a data block is associated with any one of the block numbers on the lower side, the data block is a necessary data block. In the present example, the data blocks whose block numbers are 0, 1, 2, 3, 4, 5, 6, 9, . . . are defined as necessary data blocks.

In the second download block information 174, “-” which is depicted on the lower side indicates that the corresponding data block is not a necessary data block. In the present example, the data blocks whose block numbers 7, 8, . . . are defined as unnecessary data blocks.

The block information provision section 104 generates the second download block information 174 on the basis of the content block information 164 and information regarding content that is not downloaded, which is included in the download request.

In addition, the block information provision section 104 extracts version information included in the download request, and reads the reusable block arrangement information 172 that corresponds to the version information from the recording device 120. The block information provision section 104 transmits the second download block information 174 and the reusable block arrangement information 172 to the game machine 10 (S52).

In the game machine 10, the block information acquisition section 144 acquires the second download block information 174 and the reusable block arrangement information 172 transmitted from the distribution apparatus 8, and records the second download block information 174 and the reusable block arrangement information 172 into the recording device 160.

FIG. 13(d) depicts an example of the first download block information 166. The differential data identification section 146 identifies the block numbers of data blocks in the second software 170 to be downloaded on the basis of the first download block information 166, the second download block information 174, and the reusable block arrangement information 172.

First, by referring to the second download block information 174, the differential data identification section 146 identifies, as necessary data blocks in the second software 170, the data blocks whose block numbers are 0, 1, 2, 3, 4, 5, 6, and 9.

Next, by referring to the reusable block arrangement information 172, the differential data identification section 146 determines whether the data blocks whose block numbers are 0, 1, 2, 3, 4, 5, 6, and 9 in the second software 170 are included in the first software 162. In the present example, since the data blocks whose block numbers are 0, 3, and 4, in the second software 170 are not included in the first software 162, the differential data identification section 146 defines, as targets to be downloaded, the data blocks whose block numbers are 0, 3, and 4 in the second software 170.

In addition, the differential data identification section 146 identifies that the data block whose block number 1 in the second software 170 is identical to the data block whose block number 1 in the first software 162, the data block whose block number 2 in the second software 170 is identical to the data block whose block number 2 in the first software 162, the data block whose block number 5 in the second software 170 is identical to the data block whose block number 4 in the first software 162, the data block whose block number 6 in the second software 170 is identical to the data block whose block number 5 in the first software 162, and the data block whose block number 9 in the second software 170 is identical to the data block whose block number 8 in the first software 162.

Next, by referring to the first download block information 166, the differential data identification section 146 determines whether the data blocks whose block numbers are 1, 2, 4, 5, and 8 in the first software 162, the data blocks having been identified, are included in the first software 168 which has been installed. The first download block information 166 in FIG. 13(d) indicates that the data block whose block number 5 in the first software 162 is not included. Therefore, the differential data identification section 146 additionally defines, as a target to be downloaded, the data block whose block number 5 in the first software 162, or the data block whose block number is 6 in the second software 170.

In the manner described above, the differential data identification section 146 identifies, as data blocks to be downloaded, the data blocks whose block numbers are 0, 3, 4, and 6 in the second software 170 (S54). The download execution section 148 reports the block numbers identified by the differential data identification section 146, in ascending order of the block numbers, to the distribution apparatus 8 (S56).

In the distribution apparatus 8, the game data distribution section 106 distributes the data blocks whose block numbers in the second software 170 have been reported, to the game machine 10. In the present example, the game data distribution section 106 receives, from the game machine 10, the block numbers “0,” “3,” “4,” and “6,” which are targets to be distributed, in this order, and thus, distributes, to the game machine 10, the corresponding data blocks in the second software 170 in this order.

In the game machine 10, the download execution section 148 downloads a necessary part of the data blocks in the second software 170, and records the part into the recording device 160 (S58). In the manner described above, in software updating, the game machine 10 downloads only necessary game data. Accordingly, the amount of downloaded data can be reduced.

It is to be noted that the game machine 10 standardly has a built-in recording device 160, and, in some cases, establishes a cable connection or wireless connection with an external recording device in order to expand the storage capacity. Hereinafter, the built-in recording device 160 and the external recording device are referred to as a “first recording device 160a” and a “second recording device 160b,” respectively. Operation of game software recorded in the first recording device 160a is guaranteed while operation of game software recorded in the second recording device 160b has not been guaranteed. The game machine 10 needs to copy the game software recorded in the second recording device 160b, to the first recording device 160a before executing the game software.

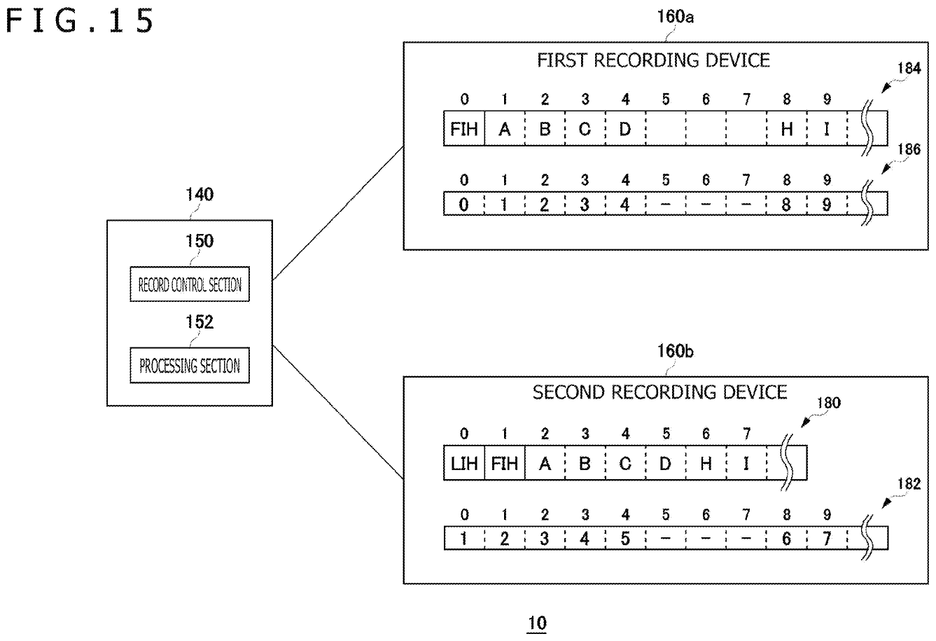

FIG. 15 depicts the game machine 10 provided with two recording devices. The processing device 140 includes a record control section 150 and a processing section 152. For example, in a case where the processing section 152 executes game software, if the game software has been recorded in the second recording device 160b, the record control section 150 executes a process of copying the game software to the first recording device 160a. After copying the first recording device 160a is completed, the record control section 150 may delete the game software from the second recording device 160b.

In the embodiment, the record control section 150 copies software 180 that is recorded in the second recording device 160b, to the first recording device 160a. In the software 180, a part of content in full-version software has been eliminated. As previously explained, content such as a language-dependent file or a play mode, for example, in the full-version software may have been eliminated in the software 180 according to a selection made by a user.

Selection block arrangement information 182 that defines correspondence between the block numbers of a plurality of data blocks in the full-version software and the block numbers of data blocks in the software 180 recorded in the second recording device 160b, is recorded in the second recording device 160b. To copy the software 180 to the first recording device 160a, the record control section 150 uses the selection block arrangement information 182.

Specifically, on the basis of the selection block arrangement information 182, the record control section 150 generates present block arrangement information 186 that associates a present data block among a plurality of data blocks in the full-version software with the corresponding block number and associates a non-present data block with information indicating the data block is not present, and records the present block arrangement information 186 into the first recording device 160a. After the software 184 is copied to the first recording device 160a, the record control section 150 may delete the selection block arrangement information 182 and the software 180 in the second recording device 160b. The processing section 152 can execute the software 184 because the respective positions of the data blocks can be identified on the basis of the copied software 184 in the first recording device 160a and the present block arrangement information 186.

It is to be noted that, since the software 184 to be executed is written into the first recording device 160a, it is preferable to transfer the software 184 execution of which is canceled, to the second recording device 160b. To copy the software 184 recorded in the first recording device 160a to the second recording device 160b, the record control section 150 generates the selection block arrangement information 182 on the basis of the present block arrangement information 186, and records the selection block arrangement information 182 into the second recording device 160b. After the software 184 is copied to the second recording device 160b, the record control section 150 may delete the software 184 and the present block arrangement information 186 from the first recording device 160a.

The present disclosure has been explained on the basis of the embodiments. The embodiments each exemplify the present disclosure. A person skilled in the art can understand that combination of the constituent elements and the processes in the embodiments can be modified in many ways, and that such modifications are also within the scope of the present disclosure. In the embodiments, game is used as an example of an application. However, any other application may be used.

For example, when game data of new-version software is downloaded in a state in which the software 180 has been recorded in the second recording device 160b, the record control section 150 may overwrite a data block that has become unnecessary in the software 180, with a data block in the new software. Accordingly, software can be efficiently recorded into the second recording device 160b.

### INDUSTRIAL APPLICABILITY

The present disclosure is applicable in the technical field of software updating.

### REFERENCE SIGNS LIST

1: Information processing system
2: PC
3: Network
4: Development use game machine
6: Diagnosis apparatus
8: Distribution apparatus
10: Game machine
20: Processing device
22: Differential data generation section
24: Block information generation section
26: Patch file generation section
28: Provision section
40: Recording device
42: Differential data
44: Reusable block arrangement information
46: Additional block arrangement information
60: Processing device
62: Record control section
64: Processing section
80: Recording device
82: First software
84: Second software
86: Patch file
100: Processing device
102: Download request acquisition section
104: Block information provision section
106: Game data distribution section
120: Recording device
122: First software
124: Second software
126: Reusable block arrangement information
140: Processing device
142: Download request transmission section
144: Block information acquisition section
146: Differential data identification section
148: Download execution section
150: Record control section
152: Processing section
160: Recording device
160a: First recording device
160b: Second recording device
162: First software
164: Content block information
166: First download block information
168: First software
170: Second software
172: Reusable block arrangement information
174: Second download block information
180: Software
182: Selection block arrangement information
184: Software
186: Present block arrangement information

1. An information processing apparatus that provides, to a recording device in which first software including a plurality of data blocks is recorded, a patch file for executing second software which is a newer version of the first software, the information processing apparatus comprising:
a block information generation section that generates reusable block arrangement information that defines correspondence between block numbers of a plurality of data blocks included in the second software and block numbers, in the first software, of common data blocks which are included in the first software and the second software in common;
a differential data generation section that generates differential data including a data block that is included in the second software but is not included in the first software;
a patch file generation section that generates a patch file including the differential data and the reusable block arrangement information; and
a provision section that provides the patch file to the recording device.

2. The information processing apparatus according to claim 1, wherein
the block information generation section generates additional block arrangement information that defines correspondence between block numbers of a plurality of data blocks included in the second software and block numbers of data blocks in the patch file, and
the patch file generation section generates the patch file including the additional block arrangement information.

3. The information processing apparatus according to claim 2, wherein correspondence between the block numbers of a plurality of data blocks included in the second software and either the block numbers of data blocks in the first software or the block numbers of data blocks in the patch file, is defined by the reusable block arrangement information and the additional block arrangement information.

4. An information processing apparatus that processes second software, which is a newer version of first software recorded in a recording device, by using a plurality of data blocks included in the first software, the information processing apparatus comprising:
a record control section that acquires a patch file including differential data and reusable block arrangement information, and records the patch file into the recording device; and
a processing section that processes the second software by using the first software and the patch file, wherein
the differential data includes a data block that is included in the second software but is not included in the first software,
the reusable block arrangement information defines correspondence between block numbers of a plurality of data blocks included in the second software and block numbers, in the first software, of common data blocks which are included in the first software and the second software in common, and
the processing section processes the second software by using the reusable block arrangement information, the first software, and the differential data.

5. The information processing apparatus according to claim 4, wherein the processing section acquires additional block arrangement information that defines correspondence between block numbers of a plurality of data blocks included in the second software and block numbers of data blocks in the patch file, and processes the second software by using the reusable block arrangement information, the additional block arrangement information, the first software, and the differential data.

6. The information processing apparatus according to claim 5, wherein correspondence between block numbers of a plurality of data blocks included in the second software and either block numbers of data blocks in the first software or block numbers of data blocks in the patch file is defined by the reusable block arrangement information and the additional block arrangement information.

7. An information processing apparatus that is capable of making access to a recording device in which first software including a plurality of data blocks is recorded and that is connected to a distribution apparatus for distributing software, the information processing apparatus comprising:
a block information acquisition section that acquires, from the distribution apparatus, reusable block arrangement information that defines correspondence between block numbers of a plurality of data blocks included in second software, and block numbers, in the first software, of common data blocks which are included in the first software and the second software in common;
a differential data identification section that identifies, in the reusable block arrangement information, a block number in the second software having no correspondence with any of the block numbers in the first software; and
a download execution section that downloads, from the distribution apparatus, a data block whose block number has been identified.

8. The information processing apparatus according to claim 7, further comprising: a download request transmission section that transmits version information on the first software to the distribution apparatus.

9. An information processing apparatus that is connected to a distribution apparatus for distributing software, the information processing apparatus comprising:
a download request transmission section that transmits a download request for first software to the distribution apparatus, the download request including information regarding content that is not downloaded among contents included in the first software;
a block information acquisition section that acquires, from the distribution apparatus, first download block information that associates a necessary data block among a plurality of data blocks included in the first software, with a corresponding block number, and associates an unnecessary data block among the plurality of data blocks, with information indicating that the data block is not downloaded;
a download section that downloads, from the distribution apparatus, the data block associated with the block number included in the first download block information; and
a recording device into which the first download block information and the downloaded data block are recorded.

10. The information processing apparatus according to claim 9, wherein
in a case where the information processing apparatus downloads second software which is a newer version of the first software,
the download request transmission section transmits a download request for the second software to the distribution apparatus, the download request including information regarding content that is not downloaded among contents included in the second software and version information on the first software,
the block information acquisition section acquires, from the distribution apparatus, second download block information that associates a necessary data block among a plurality of data blocks included in the second software, with a corresponding block number, and associates an unnecessary data block among the plurality of data blocks, with information indicating that the data block is not downloaded, and reusable block arrangement information that defines correspondence between block numbers of the plurality of data blocks included in the second software and block numbers, in the first software, of common data blocks which are included in the first software and the second software in common,
the information processing apparatus further includes a differential data identification section that identifies a block number of a data block in the second software to be downloaded, on a basis of the first download block information, the second download block information, and the reusable block arrangement information, and
the download section downloads a data block whose block number in the second software has been identified by the differential data identification section.

11. An information processing apparatus that copies software recorded in a second recording device, to a first recording device, the information processing apparatus comprising:
a record control section,
wherein software from which a part of content in full-version software has been eliminated and selection block arrangement information that associates block numbers of a plurality of data blocks in the full-version software with block numbers of data blocks in the software recorded in the second recording device, are recorded in the second recording device, and
when copying the software recorded in the second recording device to the first recording device, the record control section generates present block arrangement information that associates a present data block among a plurality of data blocks in the full-version software with a corresponding block number, and associates a non-present data block with information indicating that the data block is not present, on a basis of the selection block arrangement information, and records the present block arrangement information into the first recording device.

12. The information processing apparatus according to claim 11, wherein when copying the software recorded in the first recording device to the second recording device, the record control section generates selection block arrangement information on a basis of the present block arrangement information, and records the selection block arrangement information into the second recording device.

13. The information processing apparatus according to claim 11, further comprising: a processing section that processes the software on a basis of the present block arrangement information and the software recorded in the first recording device.

14. A non-transitory, computer readable storage medium containing a program for causing, which when executed by a computer that provides, to a recording device in which first software including a plurality of data blocks is recorded, a patch file for executing second software which is a newer version of the first software causes the computer to carry out actions, comprising:
generating reusable block arrangement information that defines correspondence between block numbers of a plurality of data blocks included in the second software and block numbers, in the first software, of common data blocks which are included in the first software and the second software in common;
generating differential data including a data block that is included in the second software but is not included in the first software;
generating a patch file including the differential data and the reusable block arrangement information; and
providing the patch file to the recording device.

15. A non-transitory, computer readable storage medium containing a program, which when executed by a computer that processes second software which is a newer version of first software recorded in a recording device by using a plurality of data blocks included in the first software, causes the computer to carry out actions, comprising:
acquiring a patch file including differential data and reusable block arrangement information, and recording the patch file into the recording device; and
processing the second software by using the first software and the patch file, wherein
the differential data includes a data block that is included in the second software but is not included in the first software,
the reusable block arrangement information defines correspondence between block numbers of a plurality of data blocks included in the second software and block numbers, in the first software, of common data blocks which are included in the first software and the second software in common,
the processing the second software, includes processing the second software by using the reusable block arrangement information, the first software, and the differential data.

16. A non-transitory, computer readable storage medium containing a program, which when executed by a computer that is connected to a distribution apparatus for distributing software and capable of making access to a recording device in which first software including a plurality of data blocks is recorded, causes the computer to carry out actions, comprising:
acquiring, from the distribution apparatus, reusable block arrangement information that defines correspondence between block numbers of a plurality of data blocks included in the second software and block numbers, in the first software, of common data blocks which are included in the first software and the second software in common;
identifying, in the reusable block arrangement information, a block number in the second software having no correspondence with any of the block numbers in the first software; and
downloading, from the distribution apparatus, a data block whose block number has been identified.

17. A non-transitory, computer readable storage medium containing a program, which when executed by a computer that is connected to a distribution apparatus for distributing software, causes the computer to carry out actions, comprising:
transmitting a download request for first software to the distribution apparatus, the download request including information regarding content that is not downloaded among contents included in the first software;
acquiring, from the distribution apparatus, first download block information that associates a necessary data block among a plurality of data blocks included in the first software with a corresponding block number, and associates an unnecessary data block among the plurality of data blocks, with information indicating that the data block is not downloaded; and
downloading, from the distribution apparatus, a data block that is associated with the block number included in the first download block information.

18. A non-transitory, computer readable storage medium containing a program, which when executed by a computer, causes the computer to carry out actions, comprising copying software recorded in a second recording device, to a first recording device, wherein
software from which a part of content in the full-version software has been eliminated and selection block arrangement information that defines correspondence between block numbers of a plurality of data blocks in the full-version software and block numbers of data blocks in the software recorded in the second recording device, are recorded in the second recording device, and
the copying software includes a function of, when the software recorded in the second recording device is copied to the first recording device, generating present block arrangement information that associates a present data block among a plurality of data blocks in the full-version software, with a corresponding block number, and associates a non-present data block among the plurality of data blocks, with information indicating that the data block is not present, on a basis of the selection block arrangement information, and recording the present block arrangement information into the first recording device.
